(19) United States
(12) Patent Application Publication
(10) Pub. No.: US 2006/0130884 A1
(43) Pub. Date: Jun. 22, 2006

(54) Pressure washer

(76) Inventor: Chih-Ming Liao, Ta-Li City (TW)

Correspondence Address: PILLSBURY WINTHROP SHAW PITTMAN, LLP, P.O. BOX 10500, MCLEAN, VA, 22102, US

(21) Appl. No.: 11/167,143

(22) Filed: Jun. 28, 2005

(30) Foreign Application Priority Data
Dec. 16, 2004 (TW) 93220287

(51) Int. Cl. B08B 3/02

(52) U.S. Cl. 134/94.1; 134/172; 134/184; 134/198

(57) ABSTRACT

A pressure washer for delivering liquid under high pressure is connected to a liquid supply, and includes a motor unit, a storage tank unit, a hydraulic pump unit, a check valve unit, and a spray nozzle. When the motor unit is started and the spray nozzle is opened, liquid is sprayed from the spray nozzle. Subsequently, when the spray nozzle is closed, the motor unit continues to operate, and a return flow passage in the check valve unit is opened so as to allow for circulation of liquid between the storage tank unit and the hydraulic pump unit.

### CROSS-REFERENCE TO RELATED APPLICATION

This application claims priority of Taiwanese Application No. 093220287, filed on Dec. 16, 2004.

### BACKGROUND OF THE INVENTION

1. Field of the Invention

This invention relates to a washer, and more particularly to a pressure washer for delivering liquid under high pressure.

2. Description of the Related Art

Referring to FIG. 1, a conventional pressure washer for delivering liquid under high pressure is connected to a tap water pipe 8, and includes a wheeled washer frame 1, a motor 2, a hydraulic pump 3 with a discharge conduit 301, a T fitting 4, a pressure sensor 5, a control unit 6, and a spray nozzle 7 connected to the discharge conduit 301. The T fitting 4 is disposed on the hydraulic pump 3. The pressure sensor 5 is disposed on the T fitting 4. The control unit 6 is in electrical connection with the motor 2 and the pressure sensor 5. When the motor 2 is started, liquid flows from the tap water pipe 8 into the spray nozzle 7 through the T fitting 4 and the discharge conduit 301.

When the spray nozzle 7 is closed, pressure builds up in the T fitting 4. As a result, the control unit 6 receives a signal from the pressure sensor 5, and therefore stops the operation of the motor 2. When the spray nozzle 7 is reopened, the pressure sensor 5 detects a decrease in the liquid pressure of the T fitting 4, and transmits a corresponding signal to the control unit 6. Hence, the control unit 6 starts the motor 2 once again. Such frequent starting results in burnout of the motor 2.

### SUMMARY OF THE INVENTION

The object of this invention is to provide a pressure washer that operates such that frequent stopping and starting of a motor unit are prevented.

According to this invention, a pressure washer for delivering liquid under high pressure is connected to a liquid supply, and includes a motor unit, a storage tank unit, a hydraulic pump unit, a check valve unit, and a spray nozzle. When the motor unit is started and the spray nozzle is opened, liquid is sprayed from the spray nozzle. Subsequently, when the spray nozzle is closed, the motor unit continues to operate, and a return flow passage in the check valve unit is opened so as to allow for circulation of liquid between the storage tank unit and the hydraulic pump unit.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a perspective view of a conventional pressure washer;

FIG. 2 is a perspective view of the preferred embodiment of a pressure washer according to this invention;

FIG. 3 is a fragmentary side view of the preferred embodiment;

FIG. 4 is an exploded perspective view of a storage tank unit of the preferred embodiment;

FIG. 5 is a partly sectional, fragmentary top view of the preferred embodiment, illustrating how a check valve unit is closed; and

FIG. 6 is a partly sectional, fragmentary top view of the preferred embodiment, illustrating how the check valve unit is opened.

### DETAILED DESCRIPTION OF THE PREFERRED EMBODIMENT

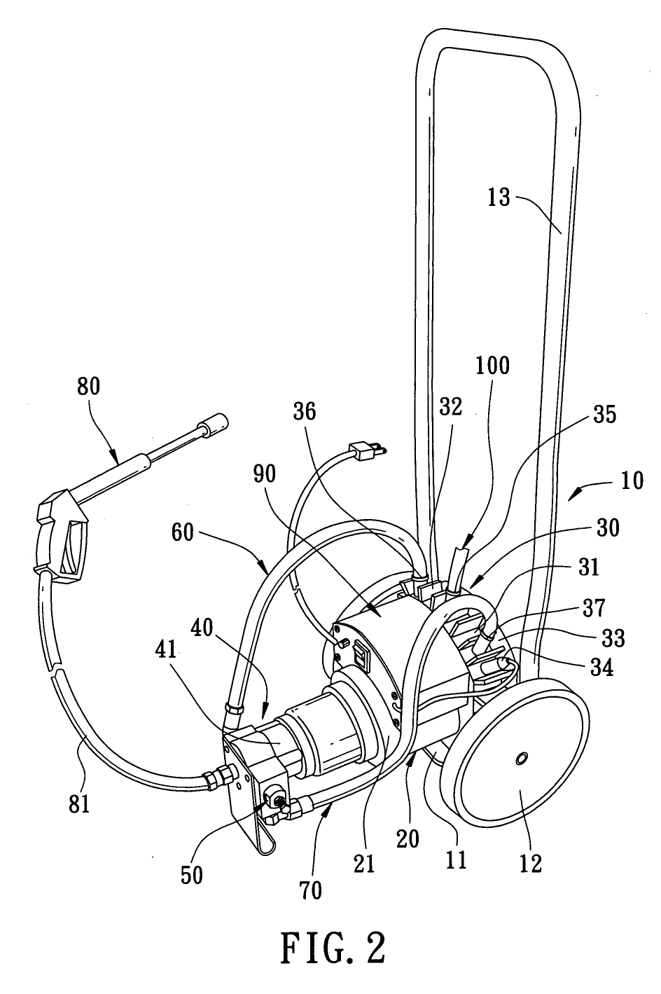

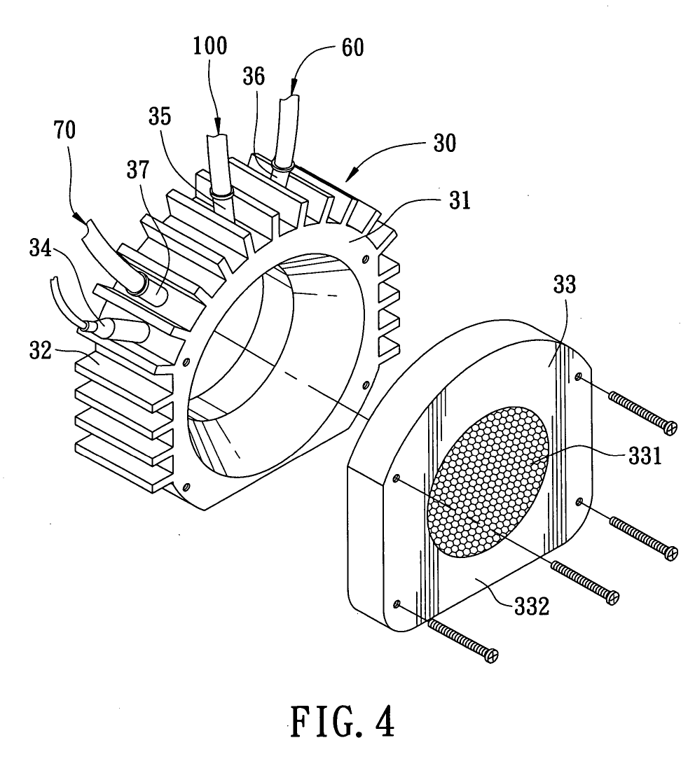

Referring to FIGS. 2, 3 and 4, the preferred embodiment of a pressure washer according to this invention is connected to a liquid supply 100, such as a tap water pipe. The pressure washer includes a washer frame 10, a motor unit 20, a storage tank unit 30, a hydraulic pump unit 40, a check valve unit 50, a first conduit 60, a second conduit 70, a spray nozzle 80 and a control unit 90.

The washer frame 10 includes a base 11, two wheels 12 disposed respectively on two opposite sides of the base 11, and an inverted U-shaped handle member 13 having two ends connected fixedly to the base 11.

The motor unit 20 is disposed on the base 11 of the washer frame 10, and includes a housing 21, an output shaft 22 journalled on the housing 21, and a heat dissipation fan 23 mounted fixedly to a rear end of the output shaft 22.

The storage tank unit 30 is disposed on a rear end of the housing 21, and is connected to the liquid supply 100. The storage tank unit 30 has a tank body 31, a plurality of heat dissipation fins 32, a net cover 33, a temperature sensor 34, an inlet 35, an outlet 36 and a return flow port 37. The tank body 31 is made of a thermally conductive material, and is disposed around the heat dissipation fan 23. The heat dissipation fins 32 extend integrally, radially, and outwardly from the tank body 31. The tank body 31 is disposed between the motor unit 20 and the net cover 33. The net cover 33 is disposed fixedly on the tank body 31, and includes a central net 331 and an annular shield 332. The shield 332 is disposed around and connected fixedly to the central net 331. The temperature sensor 34 is disposed on the tank body 31 for measuring the temperature of the tank body 31. The inlet 35, the outlet 36 and the return flow port 37 are all formed in the tank body 31. The inlet 35 is in fluid communication with the liquid supply 100. During operation of the pressure washer, the heat dissipation fins 32 cooperate with the heat dissipation fan 23 so as to dissipate heat from the motor unit 20. The control unit 90 is in electrical connection with both the temperature sensor 34 and the motor unit 20. When the temperature sensor 34 detects that the temperature of the tank body 31 reaches a predetermined temperature, the temperature 34 outputs a signal to the control unit 90. As a result, the control unit 90 stops the operation of the motor unit 20.

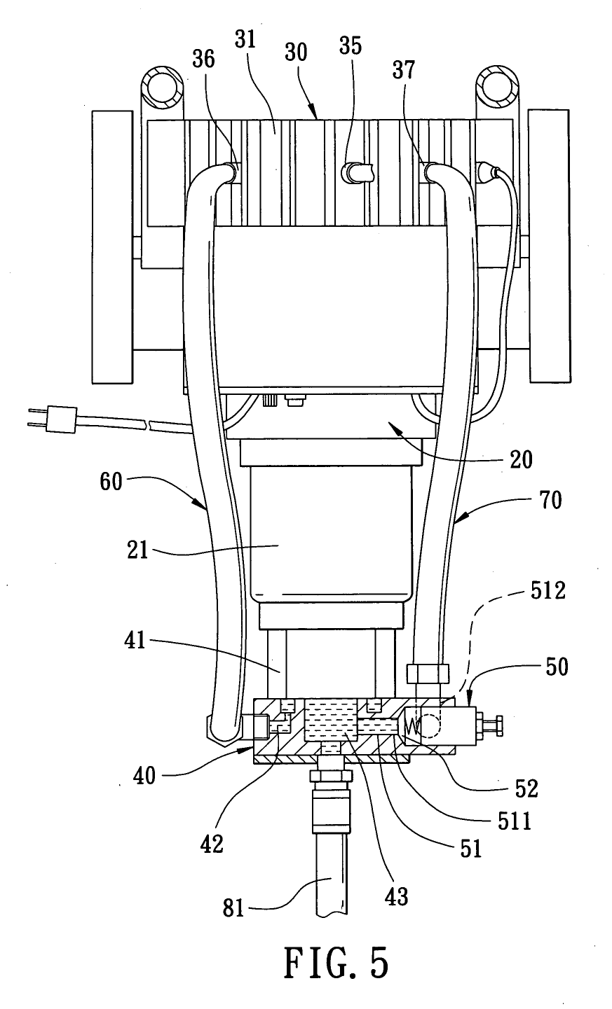

The hydraulic pump unit 40 is disposed on a front end of the housing 21 such that that housing 21 is located between the heat dissipation fan 23 and the hydraulic pump unit 40. The hydraulic pump unit 40 is connected operatively to a front end of the output shaft 22 of the motor unit 20. Referring to FIG. 5, the hydraulic pump unit 40 has a pump body 41 disposed on the housing 21, a suction port 42 and a discharge port 43 that are formed in the pump body 41. The suction port 42 is in fluid communication with the outlet 36 in the storage tank unit 30 via the first conduit 60. The discharge port 43 is in fluid communication with the return flow port 37 in the storage tank unit 30 via the second conduit 70. As such, liquid can flow from the storage tank unit 30 into the pump body 41 of the hydraulic pump unit 40 through the suction port 42. Thereafter, the liquid can flow out of the pump body 41 through the discharge port 43.

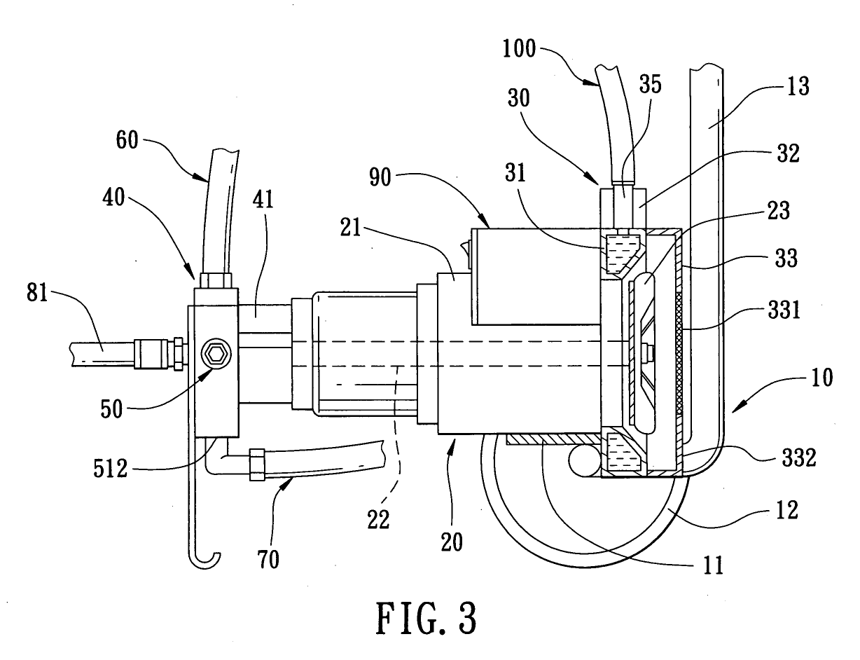

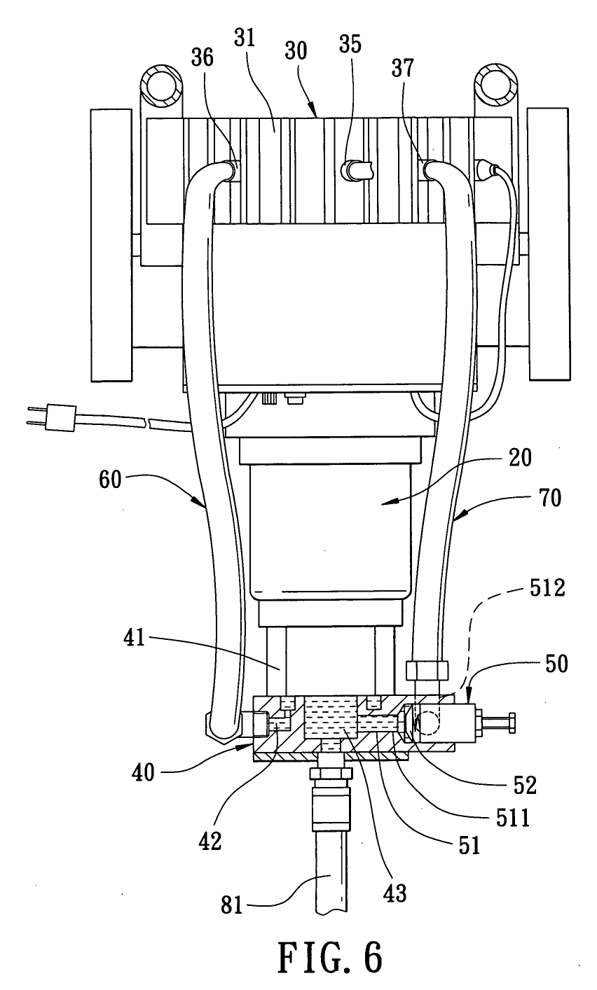

Referring to FIGS. 3, 5 and 6, the check valve unit 50 is disposed between the hydraulic pump unit 40 and the second conduit 70, and is in fluid communication with the discharge port 43 in the hydraulic pump unit 40 and the second conduit 70. The check valve unit 50 includes a return flow passage 51 formed in the pump body 41, and a spring-loaded plunger 52. The return flow passage 51 has a first end 511 in fluid communication with the discharge port 43 in the hydraulic pump unit 40, and a second end 512 in fluid communication with the return flow port 37 in the storage tank unit 30 via the second conduit 70. The plunger 52 is biased to a sealing position shown in FIG. 5, and can be moved to a non-sealing position shown in FIG. 6. In the sealing position, flow of liquid from the first end 511 of the return flow passage 51 to the second end 512 of the return flow passage 51 is prevented. When the spray nozzle 80 is closed, pressure builds up in the first end 511 of the return flow passage 51 so as to move the plunger 52 to the non-sealing position. In the non-sealing position, the flow of liquid from the first end 511 of the return flow passage 51 to the second end 512 of the return flow passage 51 is allowed.

The first conduit 60 interconnects the storage tank unit 30 and the hydraulic pump unit 40, and is in fluid communication with the outlet 36 in the storage tank unit 30 and the suction port 42 in the hydraulic pump unit 40.

The second conduit 70 interconnects the check valve unit 50 and the storage tank unit 30, and is in fluid communication with the second end 512 of the return flow passage 51 of the check valve unit 50 and the return flow port 37 in the storage tank unit 30.

The spray nozzle 80 is connected to the pump body 41 by a hose 81 that is in fluid communication with the discharge port 43. The spray nozzle 80 is selectively openable for spraying liquid.

Referring to FIGS. 2 and 5, when the motor unit 20 is started and the spray nozzle 80 is opened, liquid flows from the liquid supply 100 into the spray nozzle 80 through a flow path formed by the inlet 35 in the storage tank unit 30, the outlet 36 in the storage tank unit 30, the first conduit 60, the suction port 42 in the hydraulic pump unit 40, the discharge port 43 in the hydraulic pump unit 40, and the hose 81. In this case, since the check valve unit 50 is closed, there is no liquid flow in the second conduit 70.

Subsequently, referring to FIGS. 2 and 6, when the spray nozzle 80 is closed, the check valve unit 50 is opened so as to allow flow of liquid from the hydraulic pump unit 40 into the storage tank unit 30.

The pressure washer of this invention has the following advantages:

(1) In an operating state of the pressure washer, closing of the spray nozzle 80 results in circulation of liquid among the storage tank unit 30, the first conduit 60, the hydraulic pump unit 40, the check valve unit 50 and the second conduit 70, rather than in stopping of the motor unit 20. Therefore, burnout of the motor unit 20 resulting from frequent starting can be prevented.

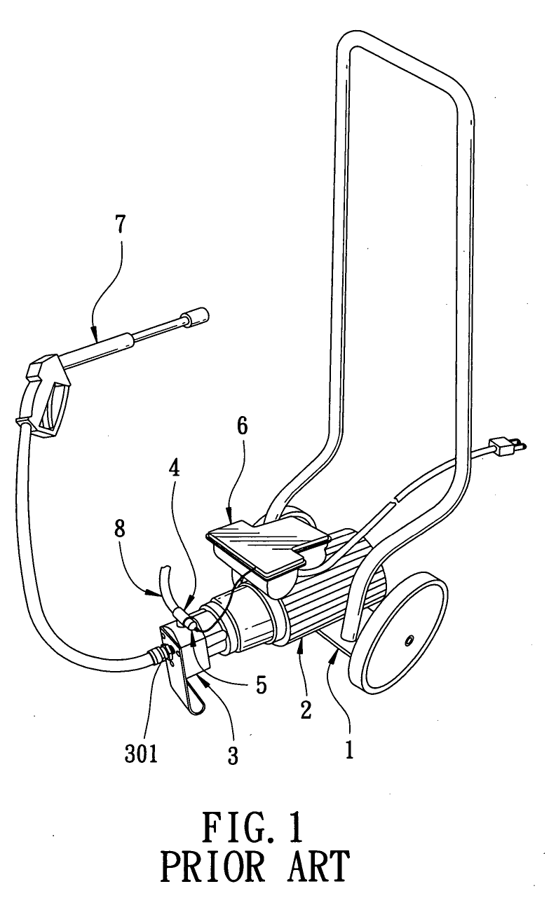

(2) Because of the omission of the pressure sensor 5 (see FIG. 1) provided in the prior art, the manufacturing costs of the pressure washer of this invention are reduced.

(3) In addition to the liquid storage function of the storage tank unit 30, the tank body 31 and the heat dissipation fins 32 of the storage tank unit 30 cooperate to serve as a heat exchanger. This facilitates heat dissipation of the motor unit 20.

With this invention thus explained, it is apparent that numerous modifications and variations can be made without departing from the scope and spirit of this invention. It is therefore intended that this invention be limited only as indicated by the appended claims.

I claim:

1. A pressure washer adapted to be connected to a liquid supply, said pressure washer comprising:
a washer frame;
a motor unit disposed on said washer frame and including a housing, an output shaft journalled on said housing, and a heat dissipation fan mounted fixedly to an end of said output shaft;
a storage tank unit disposed on an assembly of said washer frame and said housing of said motor unit and having an outlet and a return flow port;
a hydraulic pump unit connected operatively to an opposite end of said output shaft of said motor unit, said housing being disposed between said heat dissipation fan and said hydraulic pump unit, said hydraulic pump unit having a suction port in fluid communication with said outlet in said storage tank unit, and a discharge port in fluid communication with said return flow port in said storage tank unit, one of said storage tank unit and said suction port in said hydraulic pump unit being adapted to be connected to the liquid supply such that liquid can flow from the liquid supply into said hydraulic pump unit through said suction port, after which the liquid can flow out of said hydraulic pump unit through said discharge port;
a spray nozzle connected to said hydraulic pump unit and in fluid communication with said discharge port in said hydraulic pump unit, said spraying nozzle being selectively openable for spraying liquid; and
a check valve unit disposed between and in fluid communication with said return flow port in said storage tank unit and said discharge port in said hydraulic pump unit, said check valve unit being closed so as to prevent flow of liquid from said discharge port into said return flow port when said spray nozzle is opened, said check valve unit being opened so as to allow for the flow of liquid from said discharge port into said return flow port when said spray nozzle is closed.

2. The pressure washer as claimed in claim 1, wherein said storage tank unit is adapted to be connected to the liquid supply, and further has an inlet adapted to be in fluid communication with the liquid supply, liquid flowing out of said pressure washer along a flow path formed by said inlet and said outlet in said storage tank unit, and said suction port and said discharge port in said hydraulic pump unit.

3. The pressure washer as claimed in claim 2, wherein said storage tank unit further includes a tank body made of a thermally conductive material and disposed around said heat dissipation fan, and a plurality of heat dissipation fins extending integrally, radially, and outwardly from said tank body, each of said inlet, said outlet and said return flow port being formed in said tank body.

4. The pressure washer as claimed in claim 3, wherein said storage tank unit further has a net cover that is disposed fixedly on said tank body, said tank body being disposed between said motor unit and said net cover, said net cover including a central net and an annular shield that is disposed around and that is connected fixedly to said central net.

5. The pressure washer as claimed in claim 3, wherein said storage tank unit further has a temperature sensor disposed on said tank body for measuring a temperature of said tank body, said pressure washer further comprising a control unit that is in electrical connection with both said temperature sensor and said motor unit and that stops operation of said motor unit when said temperature sensor detects that the temperature of said tank body reaches a predetermined temperature.

6. The pressure washer as claimed in claim 1, wherein said hydraulic pump unit further has a pump body disposed on said housing, both said suction port and said discharge port being formed in said pump body, said check valve unit including a return flow passage formed in said pump body, and a spring-loaded plunger, said return flow passage having a first end in fluid communication with said discharge port in said hydraulic pump unit, and a second end in fluid communication with said return flow port in said storage tank unit, said plunger being biased to a sealing position, where flow of liquid from said first end of said return flow passage to said second end of said return flow passage is prevented, said plunger moving to a non-sealing position so as to allow for the flow of liquid from said first end of said return flow passage to said second end of said return flow passage when said spray nozzle is closed.

7. The pressure washer as claimed in claim 1, further comprising a first conduit in fluid communication with said outlet in said storage tank unit and said suction port in said hydraulic pump unit, and a second conduit in fluid communication with said return flow port in said storage tank unit and said check valve unit.
